(19) United States
(12) Patent Application Publication
(10) Pub. No.: US 2008/0225856 A1
(43) Pub. Date: Sep. 18, 2008

(54) NETWORK CONNECTION APPARATUS

(76) Inventor: Toyoji Kawamura, Tokyo (JP)

Correspondence Address: Jackson Chen;NEC Corporation of America, 6535 N. State Hwy.161, Irving, TX, 75039, US

(21) Appl. No.: 12/047,007

(22) Filed: Mar. 12, 2008

(30) Foreign Application Priority Data
Mar. 14, 2007 (JP) 2007-064278

(51) Int. Cl. H04L 12/56

(52) U.S. Cl. 370/395.3

(57) ABSTRACT

In a network connection apparatus having a LLDP function, a comparison processing unit compares a local chassis ID/port ID of its own apparatus with a remote chassis ID/port ID of a neighboring apparatus. When the comparison processing unit detects a coincidence between the local chassis ID/port ID and the remote chassis ID/port ID, a display unit displays an overlapped state between the local chassis ID/port ID and the remote chassis ID/port ID.

This application is based upon and claims the benefit of priority from Japanese patent application No. 2007-064278, filed on Mar. 14, 2007, the disclosure of which is incorporated herein in its entirety by reference.

### BACKGROUND OF THE INVENTION

This invention relates to a network connection apparatus, a communication system, a method and a program of avoiding overlap in information of a neighboring apparatus, and in particular to a method of avoiding the overlap of information of the neighboring apparatus in a Link Layer Discovery Protocol (LLDP).

Japanese Unexamined Patent Application Publication of Tokkai No. 2004-254,245 or JP-A 2004-254245 discloses a method of making a search for a connection candidate apparatus which is connectable to a connection source apparatus via a network such as a cable Local Area Network (LAN) or a wireless LAN. The method disclosed in JP-A 2004-254245 comprises the steps of transmitting, from the connection source apparatus, a apparatus search request on the network in a broadcast fashion, and of receiving, in the connection source apparatus, an apparatus search replay returned in response to the apparatus search request.

In addition, there is LLDP defined by IEEE (Institute of Electrical and Electronic Engineers) 802.1AB as a protocol for obtaining information of a neighboring apparatus. The LLDP defines a method comprising the steps of transmitting/receiving, in a network connection apparatus connected to a LAN, network related information to/from the neighboring apparatus on the same LAN by an LLDP frame and of storing this information in its own apparatus. However, in LLDP, a request of information is not carried out.

Herein, the network related information may be a chassis ID indicative of chassis identification information of the apparatus which transmits the LLDP frame, a port ID indicative of identification information of a port which transmits the LLDP frame, TTL (Time To Live) information indicative of the term of validity of the information stored in the received LLDP frame, and so on. In addition, a reception LLDP agent indicates an apparatus connected to the port for receiving this frame by a combination of the chassis ID and the port ID.

In a related LLDP frame processing, each of network connection apparatuses transmits a LLDP frame on the basis of IEEE802.1AB. On receiving the LLDP frame from another apparatus, the network connection apparatus uniquely identifies the other apparatus according to the chassis ID/port ID in the received LLDP frame.

However, the related LLDP frame processing is disadvantageous in that it is impossible to identify a correct state of the neighboring apparatus if a plurality of apparatuses set the same chassis ID/port ID. This is because the related LLDP frame processing may arbitrarily set the chassis ID/port ID for uniquely identifying the apparatus.

In addition, inasmuch as the related LLDP frame processing may arbitrarily set the chassis ID/port ID for uniquely identifying the apparatus, on receiving the LLDP frames from a plurality of apparatuses, the apparatus cannot make a distinction therebetween if the plurality of apparatuses set the same chassis ID/port ID.

Furthermore, the related LLDP frame processing is disadvantageous in that the related LLDP frame processing does not carry out a monitoring of an overlapped state of the other apparatus in the set chassis ID/port ID and does not display the overlapped state of the other apparatus in the set chassis ID/port ID.

That is to say, inasmuch as IEEE802.1AB defines so that the chassis ID/port ID of the LLDP frame can be arbitrarily set, there is a possibility that the same chassis ID/port ID is set in different apparatuses. As a result, the related LLDP frame processing is disadvantageous in that the apparatus receiving the LLDP frame having the same chassis ID/port ID mistakenly identifies that the received LLDP frame is transmitted from the same apparatus.

### SUMMARY OF THE INVENTION

It is an exemplary object of this invention to provide a network connection apparatus which is capable of obtaining correct information of a neighboring apparatus.

Other objects of this invention will become clear as the description proceeds.

According to an exemplary aspect of this invention, a network connection apparatus has a Link Layer Discovery Protocol (LLDP) function. The network connection apparatus includes a comparison processing unit for comparing a local chassis ID/port ID of its own apparatus with a remote chassis ID/port ID of a peripheral neighboring apparatus, and a display unit for displaying an overlapped state between the local chassis ID/port ID and the remote chassis ID/port ID when the comparison processing unit detects a coincidence between the local chassis ID/port ID and the remote chassis ID/port ID.

### BRIEF DESCRIPTION OF THE DRAWING

FIG. 1 is a block diagram of a communication system according to a first exemplary embodiment of this invention;

FIG. 2 is a block diagram of a first network connection apparatus for use in the communication system illustrated in FIG. 1;

FIG. 3 is a flow chart for use in describing operation of the first network connection apparatus illustrated in FIG. 2;

FIG. 4 is a block diagram of a network connection apparatus according to a second exemplary embodiment of this invention;

FIG. 5 is a block diagram of a network connection apparatus according to a third exemplary embodiment of this invention;

FIG. 6 is a block diagram of a network connection apparatus according to a fourth exemplary embodiment of this invention;

FIG. 7 is a block diagram of a network connection apparatus according to a fifth exemplary embodiment of this invention; and

FIG. 8 is a block diagram of a network connection apparatus according to a fourth exemplary embodiment of this invention.

### DESCRIPTION OF THE EXEMPLARY EMBODIMENTS

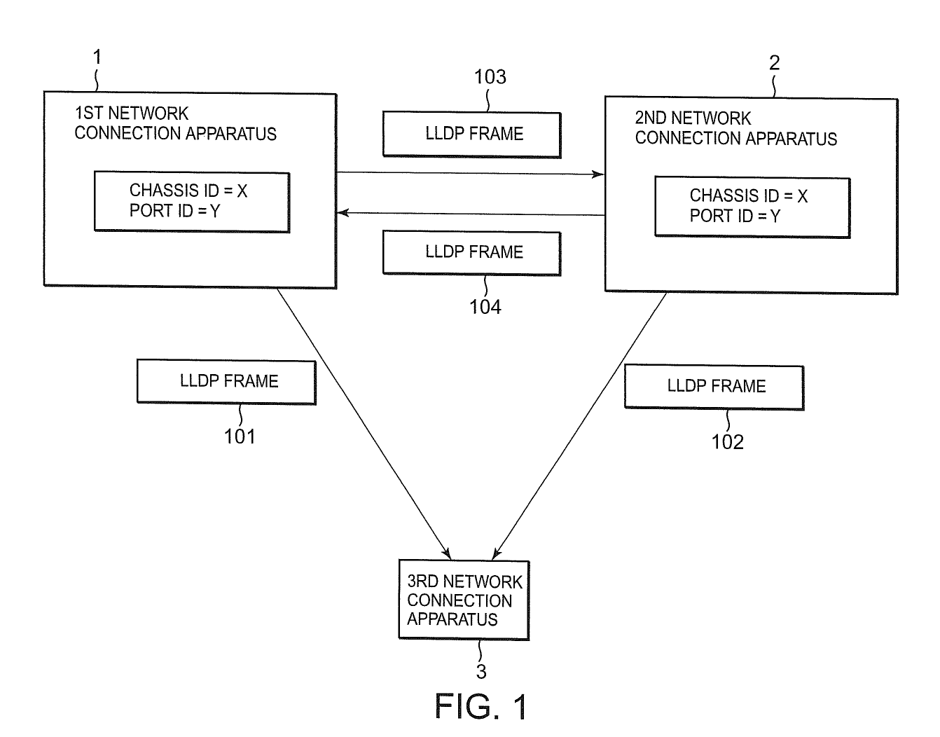

Referring to FIG. 1, the description will proceed to a communication system according to a first exemplary embodiment of this invention. The illustrated communication system comprises first through third network connection apparatuses 1, 2, and 3 which are mutually connected to one another via a network (not shown) such as an LAN (Local Area Network). Each of the first through the third network connection apparatuses 1, 2, and 3 is a network connection apparatus which is connectable to the above-mentioned network.

In the example being illustrated, it will be assumed that the third network connection apparatus 3 is operable as an own device or apparatus. In this event, the first connection apparatus 1 is called a first neighboring device or apparatus while the second connection apparatus 2 is called a second neighboring device or apparatus.

The first through the third network connection apparatuses 1, 2, and 3 transmit, to a peripheral apparatus, LLDP (Link Layer Discovery Protocol) frames 101, 102, 103, and 104 which are prepared on the basis of a chassis ID and a port ID set in its own apparatus in a multicast fashion. The LLDP frames 101, 102, 103, and 104 are called first through fourth LLDP frames, respectively.

In the example being illustrated, the first neighboring device (the first network connection apparatus) 1 transmits the first LLDP frame 101 to the own device (the third network connection apparatus) 3. The second neighboring device (the second network connection apparatus) 2 transmits the second LLDP frame 102 to the own device (the third network connection apparatus) 3. The first neighboring device (the first network connection apparatus) 1 transmits the third LLDP frame 103 to the second neighboring device (the second network connection apparatus) 2. The second neighboring device (the second network connection apparatus) 2 transmits the fourth LLDP frame 104 to the first neighboring device (the first network connection apparatus) 1.

Herein, the chassis ID indicates chassis identification information of the apparatus which transmits the LLDP frame. The port ID indicates identification information of a port which transmits the LLDP frame. In addition, a reception LLDP agent represents the apparatus connected to the port for receiving this frame by a combination of the chassis ID and the port ID.

In the example being illustrated, the first neighboring device (the first network connection apparatus) 1 is assigned with X/Y as a first local chassis ID/port ID while the second device (the second network connection apparatus) 2 is assigned with X/Y as a second local chassis ID/port ID, as shown in FIG. 1.

When the own device (the third network connection apparatus) 3 receives the first LLDP frame 101 from the first neighboring device (the first network connection apparatus) 1, the own device (the third network connection apparatus) 3 identifies or detects an existence of the neighboring device whose local chassis ID/port ID is equal to X/Y. Thereafter, the own device (the third network connection apparatus) 3 receives the second LLDP frame 102 from the second neighboring device (the second network connection apparatus) 2. Inasmuch as the second LLDP frame 102 comprises the chassis ID/port ID which is equal to X/Y, the own device (the third network connection apparatus) 3 mistakenly identifies or detects that the second LLDP frame 102 is transmitted from the first neighboring device 1.

In this event, inasmuch as the first neighboring device (the first network connection apparatus) 1 and the second neighboring device (the second network connection apparatus) 2 mutually transmit/receive the third LLDP frame 103 and the fourth LLDP frame 104, they can identify or detect an existence of the neighboring device having the same local chassis ID/port ID. At this time instance, each of the first and the second neighboring devices 1 and 2 displays overlap of the chassis ID/port ID on a display screen thereof. Accordingly, an operator of each of the first and the second neighboring devices 1 and 2 has an opportunity to resolve the overlap.

In the manner which is described above, according to the exemplary embodiment of this invention, it is possible for the operator of each of the first and the second neighboring devices 1 and 2 to give the opportunity to resolve the overlap of the chassis ID/port ID between the neighboring devices in the LLDP.

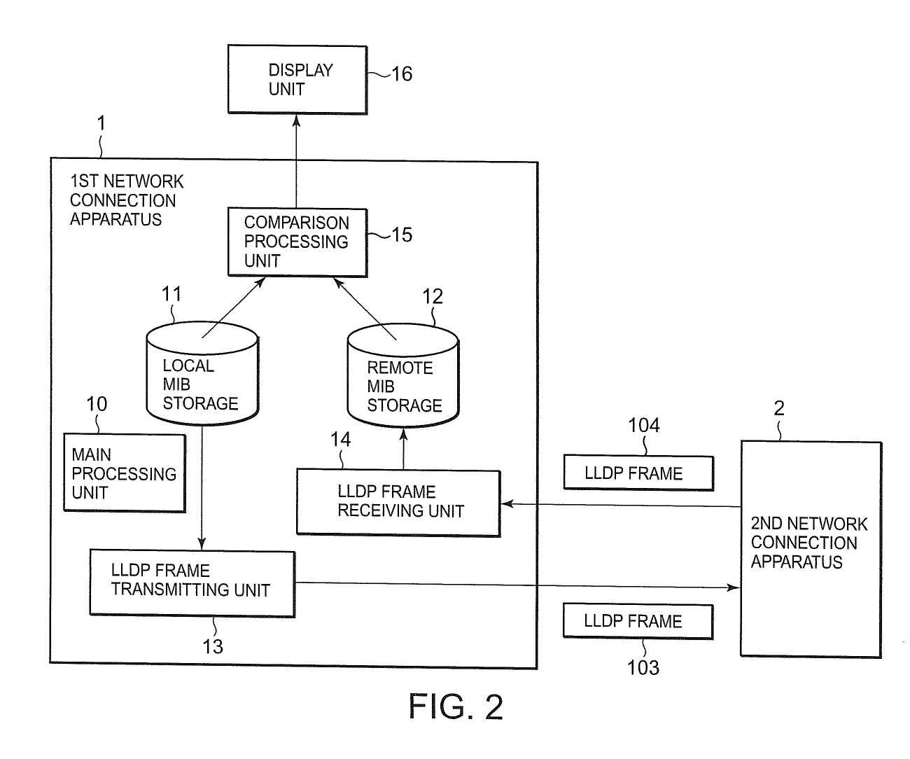

FIG. 2 is a block diagram of the first neighboring device (the first network connection apparatus) 1. The first neighboring device 1 comprises a main processing unit 10, a local MIB storage 11 for storing local MIB (Management Information Base) information, a remote MIB storage 12 for storing remote MIB information, an LLDP frame transmitting unit 13, an LLDP frame receiving unit 14, a comparison processing unit 15, and a display unit 16.

The local MIB storage 11 serves as a first holding unit for holding a local chassis ID/port ID of its own apparatus 1. The remote MIB storage 12 serves as a second holding unit for holding a remote chassis ID/port ID of a peripheral neighboring apparatus.

The main processing unit 10 controls operation of the local MIB storage 11, the remote MIB storage 12, the LLDP frame transmitting unit 13, the LLDP frame receiving unit 14, and the comparison processing unit 15.

The LLDP frame transmitting unit 13 generates the third LLDP frame 103 on the basis of information such as the chassis ID or the port ID which are set in the local MIB information stored in the local MIB storage 11 and transmits the third LLDP frame 103 to peripheral neighboring devices including the second neighboring device 2.

Transmitted the fourth LLDP frame 104 from the second neighboring device 2 to the first neighboring device 1, the LLDP frame receiving unit 14 receives the fourth LLDP frame 104 and stores, as the remote MIB information, information related to the second neighboring device 2 such as the remote chassis ID/port ID in the remote MIB storage 12.

When the remote chassis ID/port ID of the second neighboring device 2 is recorded or stored in the remote MIB storage 12, the comparison processing unit 15 retrieves the local chassis ID/port ID of its own device 1 from the local MIB storage 11, retrieves the remote chassis ID/port ID of the second neighboring device 2 from the remote MIB storage 12, and compares them. When they are coincident with each other, the comparison processing unit 15 determines that the local chassis ID/port ID of the own device 1 overlaps the remote chassis ID/port ID of the second neighboring device 2 and displays, on the display unit 16, as such (that is, a case where the overlap occurs) or an overlapped state between the local chassis ID/port ID and the remote chassis ID/port ID.

In the exemplary embodiment, one processing unit may carry out a processing of the LLDP frame in a transmitting side and a processing of the LLDP frame in a receiving side. A combination of the LLDP frame transmitting unit 13 and the LLDP receiving unit 14 may be constructed as a transmitting/receiving LLDP processing unit. In addition, each of the second neighboring device 2 and the own device 3 may be similar in structure and operation to that of the above-mentioned first neighboring device 1.

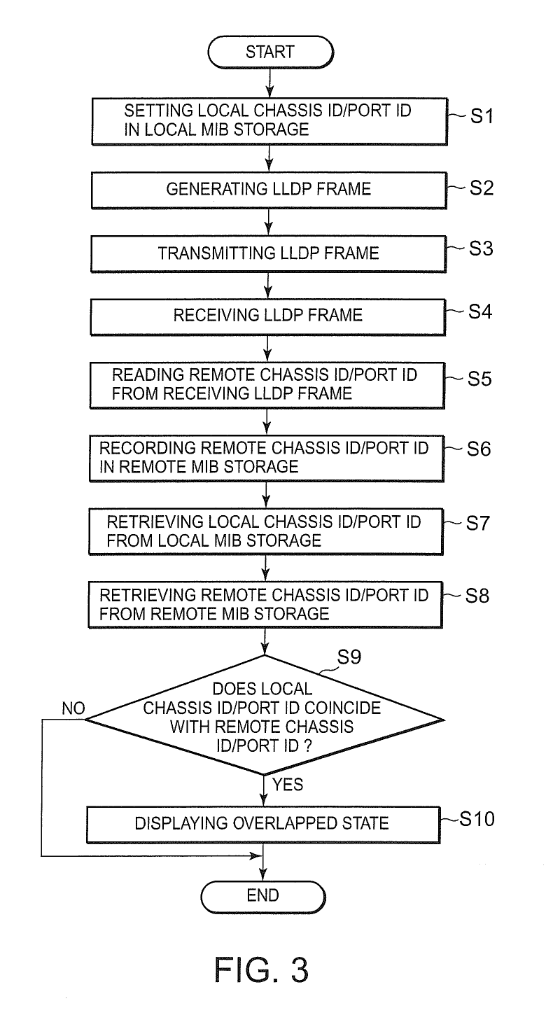

FIG. 3 is a flow chart for use in describing operation of the first neighboring device (the first network connection apparatus) 1 illustrated in FIG. 2. In addition, processing illustrated in FIG. 3 can realize by executing, in a control section (e.g. a central processing unit (CPU), a program which is executable by a computer.

Referring to FIGS. 2 and 3, the description will be made as regards operation of the first neighboring device (the first network connection apparatus) 1.

The main processing unit 10 sets or stores, as the local MIB information, the local chassis ID/port ID of its own device 1 in the local MIB storage 11 at a step S1. The step S1 is followed by a step S2 at which the LLDP frame transmitting unit 13 generates the third LLDP frame 103 on the basis of the local chassis ID/port ID of the first neighboring device 1. The step S2 is succeeded by a step S3 at which the LLDP frame transmitting unit 13 transmits the generated third LLDP frame 103 to the peripheral neighboring units including the second neighboring device 2 in a multicast fashion.

The step S3 proceeds to a step S4 at which the LLDP frame receiving unit 14 receives the fourth LLDP frame 104 from the second neighboring device 2. The step S4 is followed by a step S5 at which the LLDP frame receiving unit 14 reads the remote chassis ID/port ID of the second neighboring device 2 from the received fourth LLDP frame 104. The step S5 is succeeded by a step S6 at which the LLDP frame receiving unit 14 records or stores, as the remote MIB information, the read remote chassis ID/port ID of the second neighboring device 2 in the remote MIB storage 12.

When the remote chassis ID/port ID of the second neighboring device 20 is recorded in the remote MIB storage 12 as the remote MIB information, the comparison processing unit retrieves the local chassis ID/port ID of its own device 1 from the local MIB storage 11 as a step S7. The step S7 proceeds to a step S8 at which the comparison processing unit 15 retrieves the remote chassis ID/port ID of the second neighboring device 2 from the remote MIB storage 12.

The step S8 is followed by a step S9 at which the comparison processing unit 15 compares the local chassis ID/port ID of the own device 1 with the remote chassis ID/port ID of the second neighboring device 2. When the local chassis ID/port ID of the own device 1 coincides with the remote chassis ID/port ID of the second neighboring device 2 (YES at the step S9), the step S9 is succeeded by a step S10 at which the comparison processing unit 15 displays, on the display unit 16, the case where the overlap occurs and a processing comes to an end. When the local chassis ID/port ID of the own device 1 does not coincide with the remote chassis ID/port ID of the second neighboring device 2 (NO at the step S9), a processing comes to an end as it is.

In the manner which is described above, according to the first exemplary embodiment, inasmuch as the case where the overlap occurs is displayed on the display unit 16 when the comparison processing unit 15 compares the local chassis ID/port ID of the own device 1 with the remote chassis ID/port ID of the second neighboring device 2 to detect a coincidence of them, it is possible to avoid the overlap of the chassis ID/port ID between the first neighboring device 1 and the second neighboring device 2. It is therefore possible to obtain correct information related to peripheral devices in the first neighboring device 1, the second neighboring device 2, and the own device 3 and it is possible to resolve the problem where it regards a different device as the same device.

In addition, inasmuch as comparison of the chassis IDs/port IDs is carried out in the first neighboring device 1 and the second neighboring device 2, it is possible to avoid the overlap of the chassis ID/port ID between other devices.

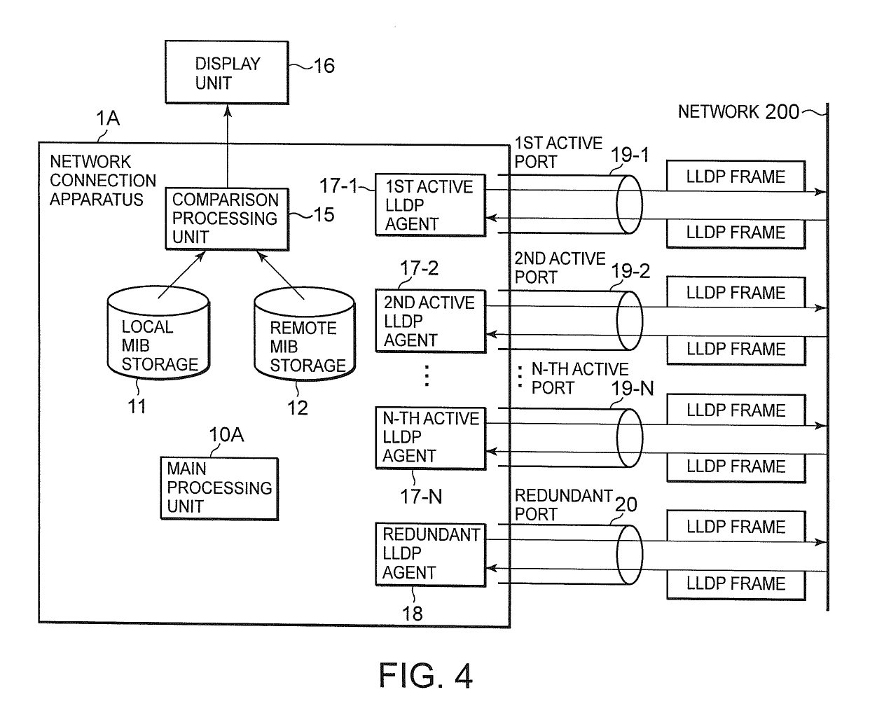

FIG. 4 is a block diagram of a network connection apparatus (a neighboring device) IA according to a second exemplary embodiment of this invention. The illustrated network connection apparatus (the neighboring device) 1A has a basic configuration which is similar to that of the first neighboring device (the first network connection apparatus) 1 illustrated in FIG. 2 but a scheme is provided to the network connection apparatus (the neighboring device) 1A about usage of a network with redundancy. Specifically, the network connection apparatus (the neighboring device) 1A has first through N-th active ports 19-1, 19-2, . . . , and 19-N and a redundant port 20, where N represents a positive integer. That is, the network connection apparatus (the neighboring device) 1A has a redundancy structure of N:1. The first through the N-th active ports 19-1 to 19-N and the redundant port 1A are connected to a network 200.

The neighboring device 10A comprises first through N-th active LLDP agents 17-1, 17-2, . . . , and 17-N which are connected to the first through the N-th active ports 19-1 to 19-N and a redundant LLDP agent 18 which is connected to the redundant port 20. Each of the first through the N-th active LLDP agent 17-1 to 17-N and the redundant LLDP agent 18 transmits and receives the LLDP frame. It is possible for one port to check, on the received LLDP frame, a survival state of other ports.

The redundant LLDP agent 18 can ensure normal states of the first through the N-th active ports 19-1 to 19-N. When the redundant LLDP agent 18 cannot receive the LLDP frame from a particular one of the first through the N-th active ports 19-1 to 19-N, the redundant LLDP agent 18 regards the particular active port as a failed port and the redundant port 20 is operable as a renewed active port in lieu of the failed port.

Among the redundant structure, the first active LLDP agent 17-1 reads the remote chassis ID/port ID from the LLDP frame received from the second active port 19-2 via the first active port 19-1 and stores the read remote chassis ID/port ID in the remote MIB storage 12. The local chassis ID/port ID of the first active port 19-1 is preliminarily stored in the local MIB storage 11 as the local MIB information.

When the remote chassis ID/port ID of the second active port 19-2 is stored in the remote MIB storage 12, the compassion processing unit 15 retrieves the local chassis ID/port ID of the first active port 19-1 from the local MIB storage 11, retrieves the remote chassis ID/port ID of the second active port 19-2 from the remote MIB storage 12, and compares them.

If the local chassis ID/port ID of the first active port 19-1 overlaps with the remote chassis ID/port ID of the second active port 19-2, the comparison processing unit 15 displays, on the display unit 16, the case where the overlap occurs. If they are not overlapped with each other, the comparison processing unit 15 carries out no processing.

In the network connection apparatus 1A, a main processing unit 10A carries out mutual monitoring of lift and death of the first through the N-th active ports 19-1 to 19-N and the redundant port 20 by means of the LLDP function.

In the manner which is described above, in the network connection apparatus 1A having the redundant structure, it is possible for an operator of the network connection apparatus 1A to have an opportunity to resolve the overlap by displaying the overlap of the chassis ID/port ID of each port. The redundant LLDP agent 18 can make a distinction between a normal state and an abnormal state of the first through the N-th active ports 19-1 to 19-N.

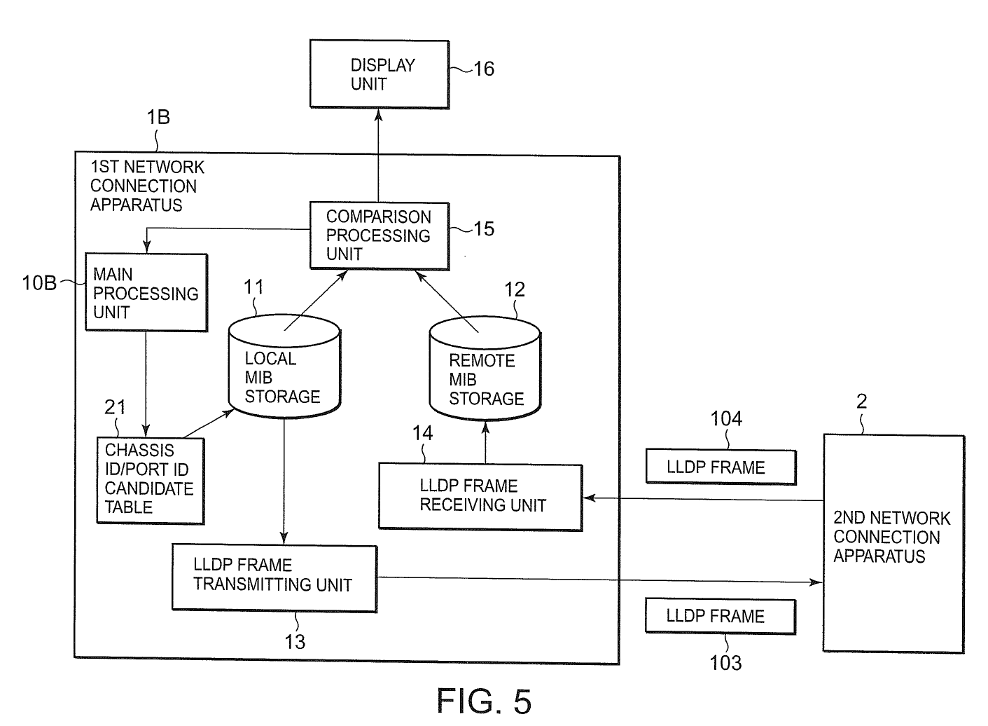

Referring to FIG. 5, the description will proceed to a first network connection apparatus (a first neighboring device) 1B according to a third exemplary embodiment of this invention. The first network connection apparatus 1B is similar in structure and operation to the first network connection apparatus 1 illustrated in FIG. 2 except that the first network connection apparatus 1B further comprises a chassis ID/port ID candidate table 21 and the main processing unit is modified from that illustrated in FIG. 2 as will later become clear. The main processing unit is therefore depicted at 10B.

The chassis ID/port ID candidate table 21 holds first through M-th desired candidates for the local chassis ID/port ID, where M represents a positive integer which is not less than two. Initially, the main processing unit 10B sets, in the local MIB storage 11, the first desired candidate for the local chassis ID/port ID held in the chassis ID/port ID candidate table 21 as the local MIB information. When the overlapped state is detected in the comparison processing unit 15, the main processing unit 10B sets, in the local MIB storage 11, the second desired candidate for the local chassis ID/port ID held in the chassis ID/port ID candidate table 21 as the local MIB information. When the overlapped state is detected in the comparison processing unit 15 again, the main processing unit 10B sets, in the local MIB storage 11, the third desired candidate for the local chassis ID/port ID held in the chassis ID/port ID candidate table 21 as the local MIB information. In the manner which is described above, the main processing unit 10B successively sets, in the local MIB storage 11, one of the first through the M-th candidates for the local chassis ID/port ID held in the chassis ID/port ID candidate table 21 as the local MIB information every when the overlapped state is detected. It is therefore possible to resolve the overlap of the chassis ID/port ID.

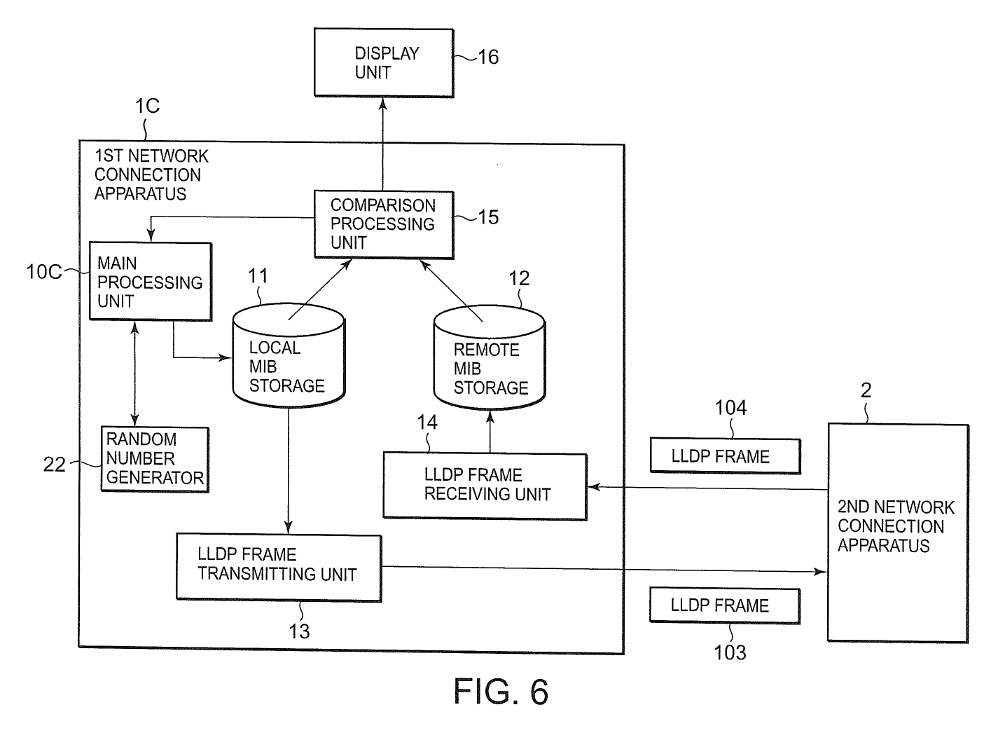

Referring to FIG. 6, the description will proceed to a first network connection apparatus (a first neighboring device) IC according to a fourth exemplary embodiment of this invention. The first network connection apparatus 1C is similar in structure and operation to the first network connection apparatus 1 illustrated in FIG. 2 except that the first network connection apparatus 1C further comprises a random number generator 22 and the main processing unit is modified from that illustrated in FIG. 2 as will later become clear. The main processing unit is therefore depicted at 10C.

Each of the chassis IDs/port IDs is divided into a sub-type and an ID. Inasmuch as the sub-type of the chassis ID/port ID is determined by the standard, the sub-type should be selected in the standard. However, it is possible to arbitrarily set the ID of the chassis ID/port ID.

Accordingly, on determining the ID of the chassis ID/port ID, the main processing unit 10C initially makes the random number generator 22 generate a random number to set, as the local chassis ID/port ID, a chassis ID/port ID including the ID equal to the ransom number in the local MIB storage 11. When the overlapped state is detected in the comparison processing unit 15, the main processing unit 10C makes the random number generator 22 generate a renewed random number again to set, as the local chassis ID/port ID, a chassis ID/port ID including the ID equal to the renewed random number in the local MIB storage 11. It is therefore possible to resolve the overlap of the chassis ID/port ID.

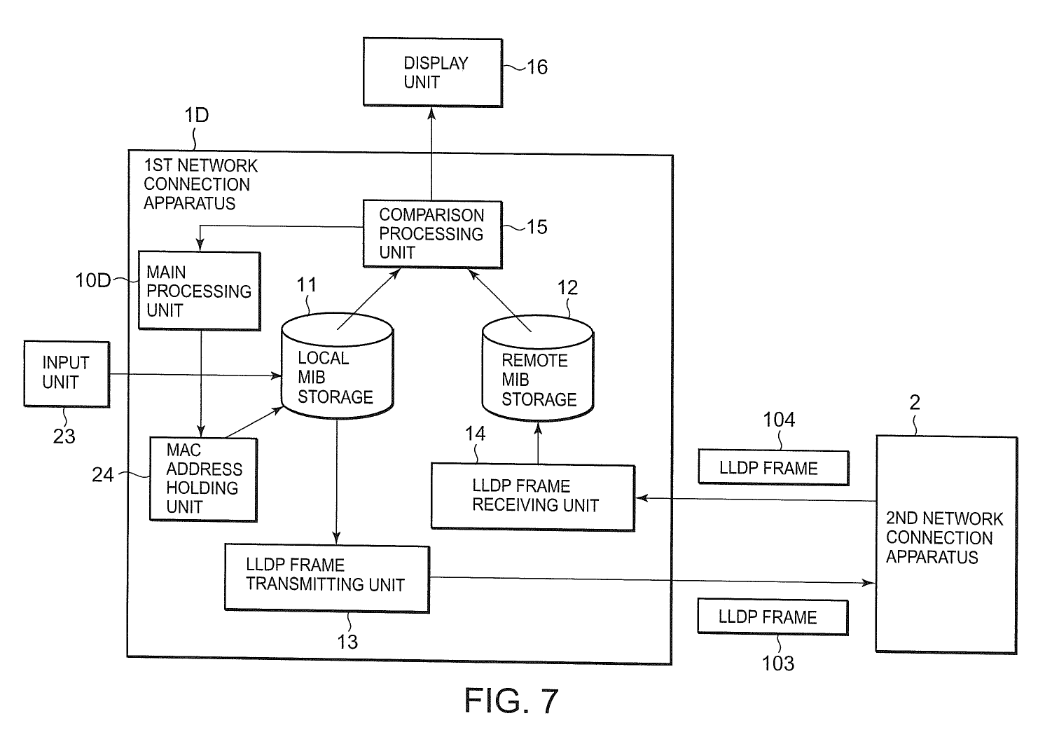

Referring to FIG. 7, the description will proceed to a first network connection apparatus (a first neighboring device) ID according to a fifth exemplary embodiment of this invention. The first network connection apparatus 1D is similar in structure and operation to the first network connection apparatus 1 illustrated in FIG. 2 except that the first network connection apparatus 1D further comprises an input unit 23 and a MAC (Media Access Control) address holding unit 24, and the main processing unit is modified from that illustrated in FIG. 2 as will later become clear. The main processing unit is therefore depicted at 10D.

The MAC address holding unit 24 holds an MAC address of its own apparatus 1D. Initially, an operator of the first network connection apparatus 1D operates the input unit 23 to arbitrarily set the local chassis ID/port ID in the local MIB storage 11. When the overlapped state is detected in the comparison processing unit 15, the main processing unit 10C activates the MAC address holding unit 24 to set, as the local chassis ID/port ID, the MAC address held in the MAC address holding unit 24 in the local MIB storage 11. Inasmuch as the MAC address is uniquely set in the world, it has an extremely low probability where any apparatus sets, as the local chassis ID/port ID, an MAC address other than that of its own apparatus. It is therefore possible to resolve the overlap of the chassis ID/port ID.

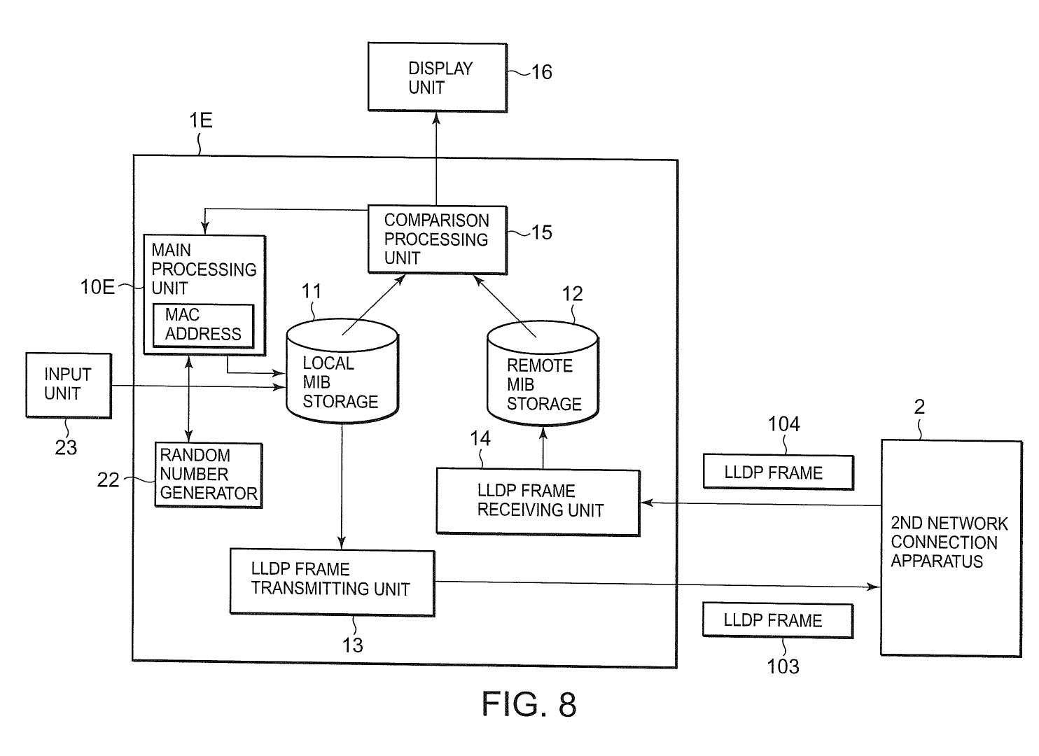

Referring to FIG. 8, the description will proceed to a first network connection apparatus (a first neighboring device) 1E according to a sixth exemplary embodiment of this invention. The first network connection apparatus 1E is similar in structure and operation to the first network connection apparatus 1C illustrated in FIG. 6 except that the first network connection apparatus further comprises the input unit 23 and the main processing unit is modified from that illustrated in FIG. 6 as will later become clear. The main processing unit is therefore depicted at 10E.

The main processing unit 10E has an MAC address for its own apparatus 1E. Initially, an operator of the first network connection apparatus 1E operates the input unit 23 to arbitrarily set the local chassis ID/port ID in the local MIB storage 11. When the overlapped state is detected in the comparison processing unit 15, the main processing unit 10E makes the random number generator 22 generate a renewed random number based on the MAC address to set, as the local chassis ID/port ID, a chassis ID/port ID including the ID equal to the random number in the local MIB storage 11. It is therefore possible to resolve the overlap of the chassis ID/port ID.

A neighboring apparatus information overlap avoiding method according to a seventh exemplary embodiment of the invention is a method of avoiding overlap of information of a neighboring apparatus for use in a network connection apparatus having a Link Layer Discovery Protocol (LLDP) function. In the neighboring apparatus information overlap avoiding method, the network connection apparatus performs comparison processing of comparing a local chassis ID/port ID of its own apparatus with a remote chassis ID/port ID of a peripheral neighboring apparatus, and display processing of displaying, on a display unit, an overlapped state between the local chassis ID/port ID and the remote chassis ID/port ID when a coincidence between the local chassis ID/port ID and the remote chassis ID/port ID is detected in the comparison processing.

A program according to an eighth exemplary embodiment of the invention is a program executed in a network connection apparatus having a Link Layer Discovery Protocol (LLDP). The program is executable in a computer. The program includes comparison processing of comparing a local chassis ID/port ID of its own apparatus with a remote chassis ID/port ID of a peripheral neighboring apparatus, and display processing of displaying, on a display unit, an overlapped state between the local chassis ID/port ID and the remote chassis ID/port ID when a coincidence between the local chassis ID/port ID and the remote chassis ID/port ID is detected in the comparison processing.

That is, in the communication system according to an exemplary embodiment of the invention, when the network connection apparatus having the LLDP (Link Layer Discovery Protocol) function receives an LLDP frame from an apparatus having a different LLDP agent, the network connection apparatus displays, on its own display screen, that there is the apparatus having an overlapped chassis ID/part ID if the chassis ID/port ID in the received LLDO frame is similar to that in its own apparatus.

An operator of the network connection apparatus, which displays that there is the apparatus having the overlapped chassis ID/port ID, has an opportunity to handle so as to change the current local chassis ID/port ID into a different local chassis ID/port ID or to request a change of the remote chassis ID/port ID of an operator of the neighboring apparatus having the overlapped chassis ID/port ID.

According to the communication system of the exemplary embodiment of the invention, inasmuch as it is possible for an apparatus's operator to have an opportunity to resolve the overlap of the chassis ID/port ID between the neighboring apparatuses in the LLDP, it is possible to obtain correct information of the neighboring apparatus and it is possible to revolve the problem that regards as the same apparatus in spite of receiving information from different apparatuses.

While this invention has been particularly shown and described with reference to exemplary embodiments thereof, the invention is not limited to these embodiments. It will be understood by those of ordinary skilled in the art that various changes in form and details may be made therein without departing from the sprit and scope of the present invention as defined by the claims.

What is claimed is:

1. A network connection apparatus having a Link Layer Discovery Protocol (LLDP) function, wherein said network connection apparatus comprises:
a comparison processing unit for comparing a local chassis ID/port ID of its own apparatus with a remote chassis ID/port ID of a peripheral neighboring apparatus;
a display unit for displaying an overlapped state between the local chassis ID/port ID and the remote chassis ID/port ID when said comparison processing unit detects a coincidence between the local chassis ID/port ID and the remote chassis ID/port ID.

2. The network connection apparatus as claimed in claim 1, wherein further comprises a first holding unit for holding the local chassis ID/port ID and a second holding unit for holding the remote chassis ID/port ID,
wherein said comparison processing unit starts a comparison processing when the remote chassis ID/port ID is held in said second holding unit.

3. The network connection apparatus as claimed in claim 1, wherein said network connection apparatus has a redundant structure of N:1, where N represents a positive integer,
wherein said network connection apparatus comprises a main processing unit for carrying out mutual monitoring of life and death of a plurality of ports by means of said LLDP function.

4. The network connection apparatus as claimed in claim 1, wherein said chassis ID indicates chassis identification information of an apparatus which transmits an LLDP frame and said port ID indicates identification information of a port which transmits the LLDP frame,
wherein a combination of said chassis ID and the said port ID represents the apparatus connected to a reception port of the LLDP frame in question.

5. The network connection apparatus as claimed in claim 2, wherein further comprises:
a table for holding predetermined first through M-th desired candidates for said local chassis ID/port ID, where M represents a positive integer which is no less than two, and
a main processing unit for successively setting, in said first holding nit, one of the first through the N-th candidates held in said table every when said overlapped state is detected.

6. The network connection apparatus as claimed in claim 2, wherein further comprises:
a random number generator for generating a random number; and
a main processing unit for initially making said random number generator generate a random number to set the random number in said first holding unit as the local chassis ID/port ID, said main processing unit making said random number generator generate a renewed random number to set the renewed random number in said first holding unit as said local chassis ID/port ID when said overlapped state is detected.

7. The network connection apparatus as claimed in claim 2, said first holding unit arbitrarily holding the local chassis ID/port ID, wherein said network connection apparatus further comprises:
a Media Access Control (MAC) address holding unit for holding an MAC address for its own apparatus; and
a main processing unit for activating said MAC address holding unit to set the MAC address in said first holding unit as a renewed local chassis ID/port ID when said overlapped state is detected.

8. The network connection apparatus as claimed in claim 2, said first holding unit arbitrarily holding the local chassis ID/port ID, wherein said network connection apparatus further comprises:
a random number generator for generating a random number; and
a main processing unit having a Media Access Control (MAC) address for its own apparatus, said main processing unit making said random number generator generate a random number based on said MAC address to set the random number in said first holding unit as a renewed local chassis IS/port ID when said overlapped state is detected.

9. A communication system including the network connection apparatus as claimed in claim 1.

10. A method of avoiding overlap of information of a neighboring apparatus for use in a network connection apparatus having a Link Layer Discovery Protocol (LLDP) function, wherein said network connection apparatus performs:
comparison processing of comparing a local chassis ID/port ID of its own apparatus with a remote chassis ID/port ID of a peripheral neighboring apparatus; and
display processing of displaying, on a display unit, an overlapped state between the local chassis ID/port ID and the remote chassis ID/port ID when a coincidence between the local chassis ID/port ID and the remote chassis ID/port ID is detected in said comparison processing.

11. The method as claimed in claim 10, wherein said network connection apparatus comprises a first holding unit for holding the local chassis ID/port ID and a second holding unit for holding the remote chassis ID/port ID,
wherein said network connection apparatus starts said comparison processing when the remote chassis ID/port ID is held in said second holding unit.

12. The method as claimed in claim 10, wherein said network connection apparatus has a redundant structure of N:1, where N represents a positive integer,
wherein said network connection apparatus carries out mutual monitoring of life and death of a plurality of ports by means of said LLDP function.

13. The method as claimed in claim 10, wherein said chassis ID indicates chassis identification information of an apparatus which transmits an LLDP frame and said port ID indicates identification information of a port which transmits the LLDP frame,
wherein a combination of said chassis ID and the said port ID represents the apparatus connected to a reception port of the LLDP frame in question.

14. The method as claimed in claim 11, wherein said network connection apparatus comprises a table for holding predetermined first through M-th desired candidates for said local chassis ID/port ID, where M represents a positive integer which is no less than two,
wherein said network connection apparatus successively sets, in said first holding unit, one of the first through the N-th candidates held in said table every when said overlapped state is detected.

15. The method as claimed in claim 11, wherein said network connection apparatus performs:
initial generation processing of initially generating a random number to set the random number in said first holding unit as the local chassis ID/port ID; and
renewal generation processing of generating a renewed random number to set the renewed random number in said first holding unit as said local chassis ID/port ID when said overlapped state is detected.

16. The method as claimed in claim 11, wherein said network connection apparatus performs:
arbitrary holding processing of arbitrarily holding the local chassis ID/port ID in said first holding unit; and
renewal setting processing of setting a Media Access Control (MAC) address in said first holding unit as a renewed local chassis ID/port ID when said overlapped state is detected.

17. The method as claimed in claim 11, wherein said network connection apparatus performs:
arbitrary holding processing of arbitrarily holding the local chassis ID/port ID; and
renewal generation processing of generating a random number based on a Media Access Control (MAC) address for its own apparatus to set the random number in said first holding unit as a renewed local chassis ID/port ID when said overlapped state is detected

18. A program executed in a network connection apparatus having a Link Layer Discovery Protocol (LLDP), said program being executable in a computer, wherein said program includes:
comparison processing of comparing a local chassis ID/port ID of it's own apparatus with a remote chassis ID/port ID of a peripheral neighboring apparatus; and
display processing of displaying, on a display unit, an overlapped state between the local chassis ID/port ID and the remote chassis ID/port ID when a coincidence between the local chassis ID/port ID and the remote chassis ID/port ID is detected in said comparison processing.
